(19) United States
(12) Patent Application Publication
(10) Pub. No.: US 2013/0248340 A1
(43) Pub. Date: Sep. 26, 2013

(54) Electric SMD Type Switching Element

(71) Applicants: Hanna Lehmann, Olten (CH); Markus Fuchser, Birr (CH)

(72) Inventors: Hanna Lehmann, Olten (CH); Markus Fuchser, Birr (CH)

(73) Assignee: EAO HOLDING AG, Olten (CH)

(21) Appl. No.: 13/990,500

(22) PCT Filed: Dec. 2, 2011
(86) PCT No.: PCT/EP2011/071663

§ 371 Date: May 30, 2013

(30) Foreign Application Priority Data
Dec. 3, 2010 (EP) 10193639.1

(51) Int. Cl. H01H 13/10

(52) U.S. Cl. CPC H01H 13/10
USPC 200/530

(57) ABSTRACT

An electric SMD type switching element has a body incorporating the switching element, at least two contact surfaces, which are provided on the underside of the body for mounting an SMD, and an actuating element provided on the side opposing the underside, which is movably connected to the body as a moving portion in keeping with the longitudinal axis of the switching element. Here, an electrically conducting connection is created between the contacts via a switching contact, which can be closed by the movement of the actuating element relative to the switching contact. The body has a lower section featuring the two contact surfaces and the switching contact, and an upper section incorporating the actuating element.

### TECHNICAL FIELD

The present invention concerns an SMD type electric switching element in accordance with the preamble of Claim 1, in particular, an electrically illuminating push button of the SMD type.

### PRIOR ART

The SMD manufacturing process, whereby the abbreviation stands for Surface Mounted Device, is a technique for populating printed circuit boards that presents multiple advantages. If a computerized populating method is used, the electric elements to be inserted can be soldered directly on the surface of a printed circuit board. Since no parts of the electric components pierce through the printed circuit board, it is advantageous that both sides of the printed circuit board can be populated with circuits.

An optical contact switch is known from DE 10 2006 040 803, which is arranged as an SMD component on a support featuring SMS contacts, which can then be electrically connected with the conductor path of a printed circuit board.

Thereby, the insertion effort for attaching a switch onto a printed circuit board can be reduced. The four lateral SMD contacts allow contact between the plate-type optical switching element and a printed circuit board. The switch is protected against direct contact by a cover panel and functions as an optical contact switch.

### DESCRIPTION OF THE INVENTION

Based on this prior art, the object of the invention is to describe an electric SMD type switching element of the type mentioned at the beginning, which is designed as a pressure switch. A further objective of the invention is to describe an illuminated SMD push button.

Another object of the present invention is to enhance the operational reliability of this type of switch.

This object has been achieved with the characteristics of Claim 1 according to the invention.

An electric SMD type switching element has a body incorporating the switching element, at least two contact surfaces arranged on the underside of the body for attaching the SMD, and an actuating element arranged on the opposite side from the underside, which is movably connected to the body as a moving portion in keeping with the longitudinal axis of the switching element. Thereby, an electrically conducting connection is now established between the contacts via a switching contact, which can be closed by the relative movement of the actuating element, in particular, a movement along the longitudinal axis of the switching element that is the central axis vertical to the printed circuit board, relative to the switching contact. The body now has a lower section, which features the two contact surfaces and the switching contact, and an upper section, which comprises the actuating element. At the same time, the lower section and the upper section should be connected via complimentary catch mechanisms. Thereby, the lower section can be manufactured from a plastic capable of withstanding the heat of soldering an SMD, while the upper section can be manufactured using conventional materials. This is only placed on the lower section after soldering, and the switch or push button is completed.

The second object is achieved with the characteristics of Claim 7. This type of switching element has an actuating element with an actuating lug, with which the contacts can be closed by the said movement of the actuating element relative to the switching contact. Advantageously, the switching contact is a flexible blade, which is permanently connected to a contact (soldered, for example), and has a section projecting into the movement range of the actuating lug, which can therefore be pushed away. Here, the switching contact is an elongated spring, which is divided into at least two parallel flexible blades by at least one slot running lengthwise. Here, with two or more longitudinal slots, these at least partially differ in length, whereby all slots pierce at least the contact area between the blade and the counter contact, whereby at least one projects into the end range of the flexible blades.

Further embodiments are indicated in the dependent Claims.

### BRIEF DESCRIPTION OF THE DRAWINGS

Preferred embodiments of the invention are described in the following by reference to the drawings, which only serve the purposes of explanation and should not be interpreted as limiting. The drawings depict:

FIG. 1 a partially cutaway cross-section view of two push buttons in accordance with one example of the realization of the invention arranged next to each other on a printed circuit board,

FIG. 2 a perspective view of a pressure switch from FIG. 1,

FIG. 3 an exploded view of the switch in accordance with FIG. 2,

FIG. 4 a partially cutaway perspective view of the lower section of the push button in accordance with FIG. 2, featuring redundant contact,

FIG. 5 a partially cutaway plan view of the lower section in accordance with FIG. 4, and

FIG. 6 a partially cutaway cross-section view of the push button mounted on a printed circuit board.

### DESCRIPTION OF PREFERRED EMBODIMENTS

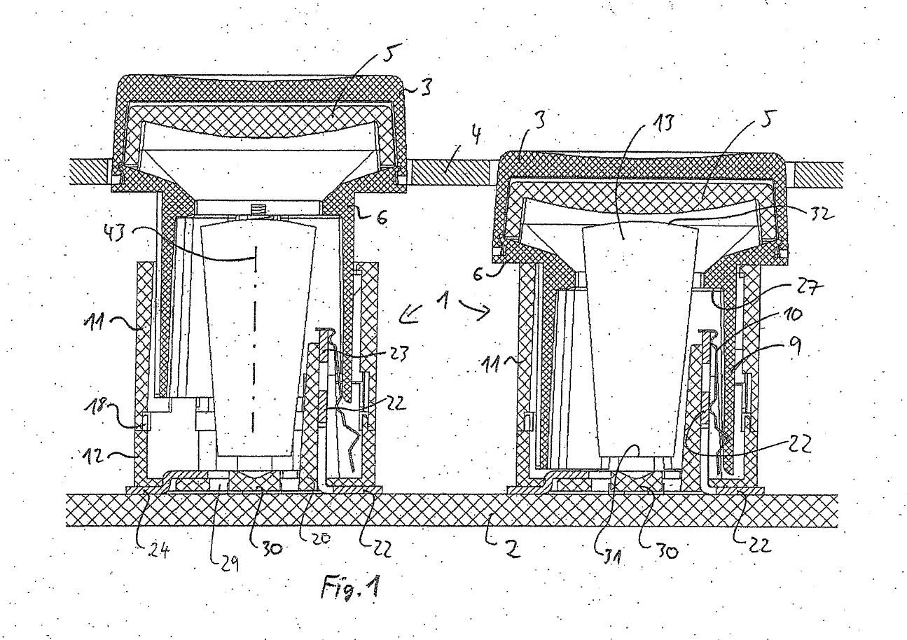

FIG. 1 shows a partially cutaway cross-section view of two push buttons 1 arranged next to each other on a printed circuit board, which are connected to a printed circuit board 2, whereby the actuation caps 3 of the push button 1 project through a front panel 4. The electric SMD type switching element in accordance with the invention is an electrically illuminated push button or pressure switch. The depiction of the printed circuit board 2 is schematic. On a control panel, a printed circuit board 2 is usually fitted with an appropriate circuit, which can be switched via various actuating elements, in particular the push button 1. Here, the printed circuit board 2 is arranged in a frame underneath the front panel 4 of an operating console, whereby the actuation caps 3 of the control elements project as far as the front panel 4. On the left-hand side of FIG. 1, the push button 1 has not been activated, that is, the contact has not been closed, while for the pressed push button 1 on the right-hand side of the depiction, the contact has been closed.

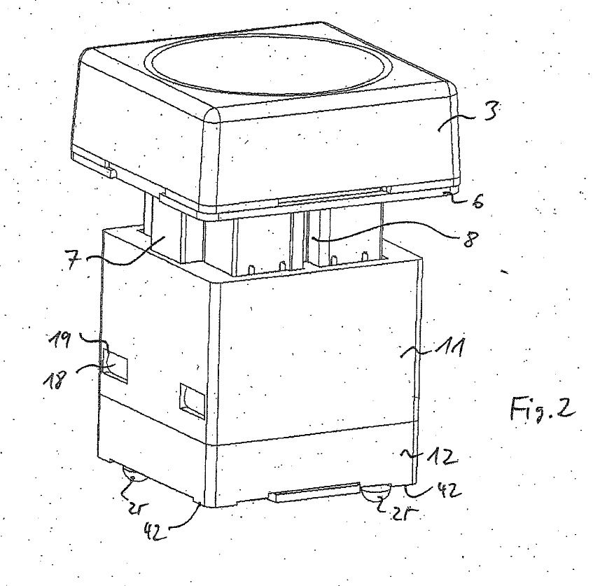

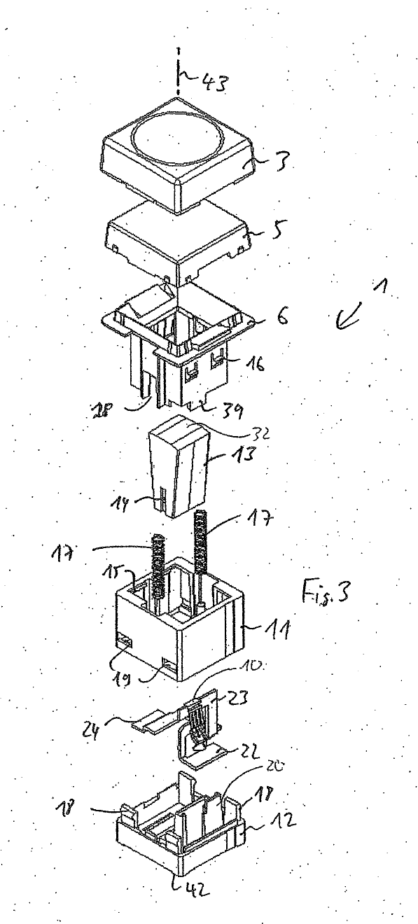

The structure of the push button 1 will now be described in more detail in association with the perspective depiction in FIG. 2 and the exploded view in FIG. 3.

In place of a push button 1, which clicks into place on the detachable snap-in lugs 15 and 16 and consequently defines an ON and an OFF position, it can also be a simple rocker switch, which returns to its initial position after contact, whereby the illumination would have to be designed differently due to the greater distance from the optical fiber 13 to the diffuser 5.

The push button 1 consists of multiple operating elements, which are prefabricated as a unit and incorporate the pressure cap 3 as a protruding element. Advantageously, the pressure cap 3 already consists of multiple parts and consists of a transparent pressure cap 3 as such, under which an also transparent diffuser cap 5 is arranged. This advantageous double arrangement allows labeling foils to be inserted between the pressure cap 3 and the diffuser 5 or, for example, direct laser labeling of the surface of the diffuser 5, which is then protected from abrasion due to the use of the pressure cap 3. In principle, a one-piece embodiment is also possible here. The pressure cap 3 clips onto a guide frame 6. This embodiment of the connection of the pressure cap 3 and the diffuser 5 is known in principle and could also be produced by means of bonding or welding. The guide frame 6 has multiple slide sections moving down from the pressure cap 3, of which one is designated by Reference Symbol 7. A corresponding profile groove 8 of the guide frame 6 has been labeled as Reference Symbol 8.

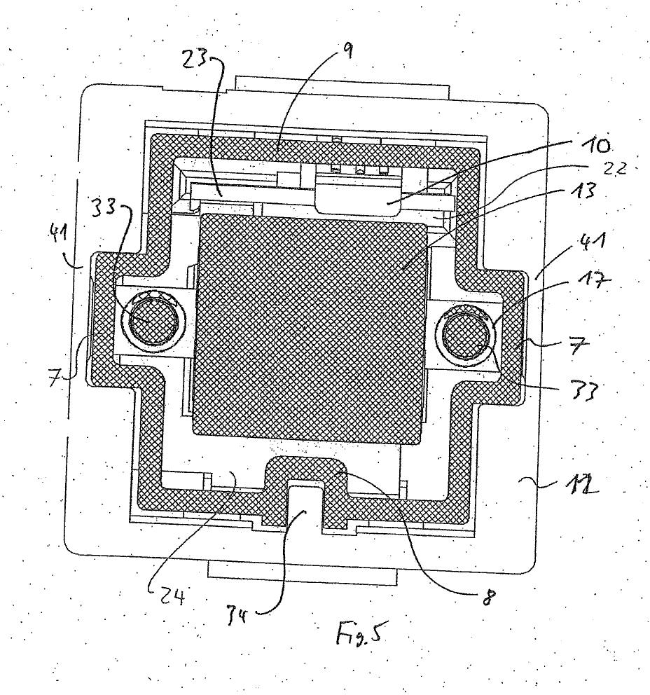

Furthermore, the guide profiles 7 forming a closed frame, as depicted in the cutaway plan view in FIG. 5, incorporate an actuation panel 9, with which the contact blade 10 of the push button 1 can be switched. This operating part of the switch 1, in particular, moves along its main axis 43 towards the upper section 11 of the switch and the lower section 12 of the switch. These actuating elements 3, 6, 9 clip advantageously into the upper section 11 of the switch, such that the said longitudinal movement between the upper section 11 and the operating elements 3 and 6 of the push button is possible, but these elements, both prior to assembly as well as following assembly, do not fall apart on being operated. The optical fiber 13 is integrated in this frame that is connected in particular to the upper section 11. The optical fiber 13 is set centrally in the upper section 11 and in the guide frame 6. Here, the guide frame 6 can be clasped by the lug 16 located in a recess, in and under the corresponding lugs 15 in the upper section 11.

The optical fiber 13 meshes into corresponding connection lugs in the upper section 11 with lateral notches 14. Corresponding recesses 28 are provided in the guide frame 6 for this purpose, such that the guide frame 6 can be moved longitudinally over the optical fiber 13 and between its connection with the upper section 11, that is, along the main axis 43 of the button.

Hence, after operating the switch, the guide frame 6 returns to its initial position, shown on the left in FIG. 1, with the pressure cap 3. Two springs 17 are provided, which are supported on a base plate provided in the upper section 11 and have their counter bearing opposite, on a lower edge of the guide frame 6 in the upper section 11.

The lower section 12 of the push button 1 has four snap-in lugs 18. The snap-in lugs 18 are arranged on the lateral surfaces of the lower section 12, on opposite sides respectively. Here, in each case, two are arranged near the corners. The snap-in lugs 18 extend upwards in the direction from which the upper section 11 can be positioned and they can be positioned in corresponding lug seatings 19 in the upper section 11 and can then be snapped into place. Hence, the lower section 12 and the upper section 11 can be connected to the installed, separately snapped-in operating part 3, 6, 13, as one functional unit.

The lower section 12 has a contact support 20 extending into the upper section 11, which, for example, can be formed as one piece with and from the same material as this. The contact 23 ends on the contact support 20 in a contact strip running along the upper edge, on which a free end of the contact blade 10 is fixed, in particular, soldered on. The other end of the contact blade 10 with the Reference Symbol 40 extends to the side of the contact support 20 turned towards the outer side of the housing. This is arranged with a lateral clearance from a counter contact 22 which essentially runs in the contact support 20 in its principal plane and hence is arranged with its broad surface opposite the contact blade 10 and a section of spring 35. The counter contact 22, then, has a surface on the external surface of the lower section 12, which is designed for contact with the printed circuit board 2. In FIG. 3 it can also be seen that the contact 23 can be connected to the printed circuit board 2 via a connection on the inside of the housing via the contact plate 24. The contact plate is set down behind a shoulder and, along with the corresponding contact plate 22, is located on the underside 42 of the lower section 12, for example in a corresponding recess. In particular, these contact surfaces line up precisely with the underside 42 of the lower section 12.

The run of the contact sequence as depicted is advantageous for the depicted example of the realization of the invention. Initially, however, only the incorporation of the SMD-capable contacts 22 and 24 on the lower section 12 is essential, whereby one part of the contact chain 24-23-20-35-22, namely the contact 35, can be actuated by the actuating lug 39 of the upper section 11.

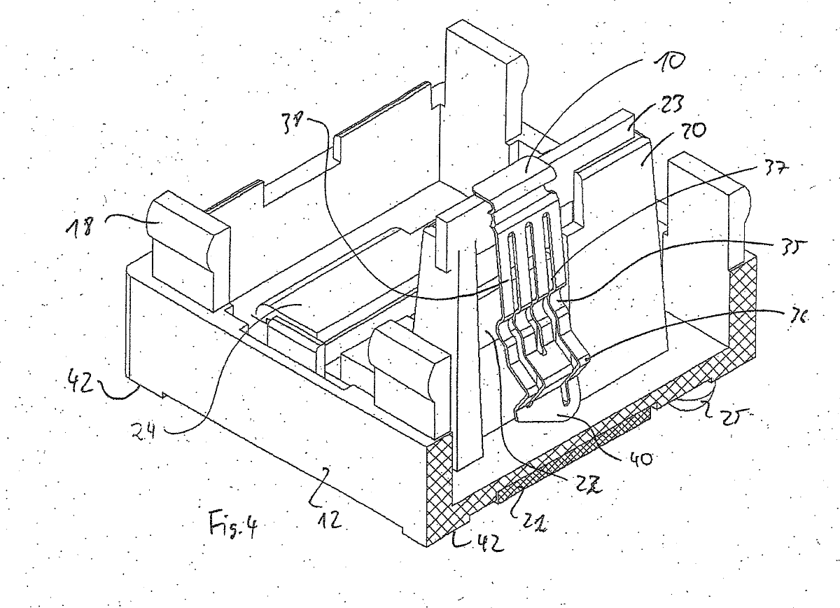

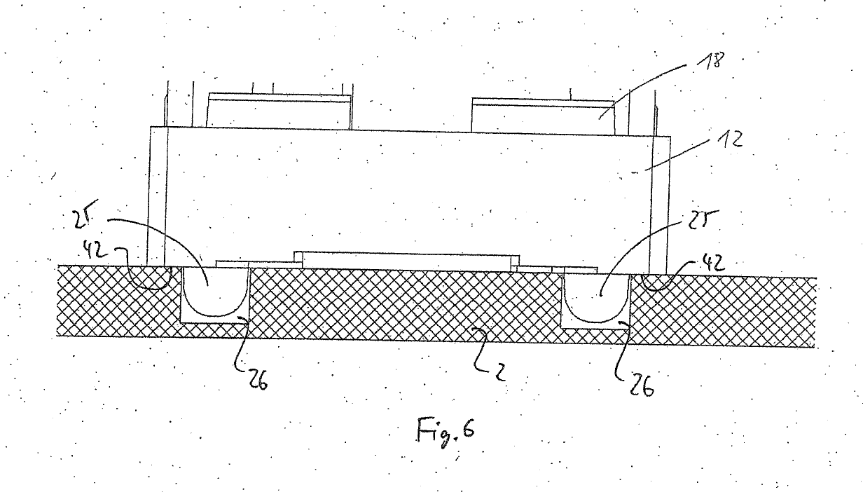

Positioning guides 25 are also depicted in FIGS. 2 and 4, two of which can be provided in particular on diametrically opposite corners of the underside 42 of the lower section 12. These, then, protrude, as shown in FIG. 6, preferably from the component side of the push button 1 into blind holes 26 provided in the printed circuit board 2. This positioning aid makes sense, particularly when mounting the lower sections 12 on the printed circuit board 2 manually, while these positioning guides 25 are not necessary and therefore can be omitted where SMD mounting is automated. Hence, they enhance the versatility of the push button 1 in multiple embodiments for various customer requirements.

For an illuminated SMD button 1 in accordance with the invention, it is advantageous that due to the frame design of the lower section 12 there is an internal cavity or aperture 29, in which one, two or three LEDs 30, in particular LED SMDs, can be mounted on the printed circuit board 2. Here, the optical fiber 13 is positioned in respect of the upper section 11, and hence, via the direct connection with the lower section 12, also fixed in position in respect of the printed circuit board 2, such that the underside 31 of the optical fiber 13, which preferably forms a smooth rectangular surface 31, is arranged with as little clearance as possible, of 2 to 3 mm above the upper edge of the SMD-connected LEDs 30. Hence, with the advantageously curved, here plano-convex, upper shape 32, which combines with the plano-concave design of the diffuser cap 5, a good luminous efficiency can also be guaranteed.

The segmentation of the housing of the push button 1 into a lower section 12 able to be inserted as an SMD and an upper section 11 incorporating the operating part 5, 6, 8 and the optical fiber 13 is important in terms of manufacturing.

In this type of illuminated push button 1, the well-aligned arrangement of the optical fiber 13 fixed opposite the upper part of the housing 11 and the guidance of the pressure cap 3 opposite this upper part of the housing 11 is crucial. This increased precision in the manufacture of components is temperature-sensitive and the upper housing part 11 should therefore not be exposed to increased temperatures, as it would normally be during SMD soldering. Therefore, this component 11 of the push button 1 is separated from the component 12, which, together with the contact 20, 22, 23 and 24 preferably integrated into this, can be soldered on the printed circuit board 2 in SMD architecture. For this reason, the lower section 12 consists of a high-temperature resistant plastic, possibly quite contrary to the upper section 11, for which conventional plastics can be utilized, such that, in terms of its dimensions, the lower section 12 will not warp due to the impact of heat during the SMD mounting process. Hence, after this mounting step, the upper section 11 can then be clipped on in order to assemble the finished push button 1.

A high-temperature resistant plastic, which withstands the temperatures occurring during the soldering and remains dimensionally stable when the SMD is soldered, is suitable for the lower section 12. In the process, depending on the method and soldering furnace used, temperatures, in particular, from 180 to 280 degrees Celsius, can occur over a period of 1 to 2 minutes. Thermostable means that the lower section does not change or only changes negligibly with respect to its original shape prior to soldering, that is it physically and materially exhibits the same external shape and it also, advantageously, exhibits no chemically altered characteristics.

FIG. 5 is a good depiction of some of the elements of the drawings described above in a partial cutaway plan view, in particular, the positioning of the springs 17 on the corresponding cylinders 33 and the three guide profiles, the laterally overhanging profiles 7 and the profile groove 8, into which a lug 34 of the upper section 12 projects. A complementary recess 41 in the side panel of the upper section 11 faces the profile 7, which reduces the panel thickness. Here, it should be noted that, if the upper section 11 facing the guide frame 6 becomes hot, that is, exhibits a substantial difference in temperature, this would damage the guidance characteristics between the sliding surfaces 7-41 and 8-34. After assembly, three-point guidance with respect to the interior panel of the upper part of the housing 11 is provided by the elements 7 and 8, with a noise-reduced surface feel.

Furthermore, it should be realized that the base of the optical fiber 13 occupies a substantial part of the internal space of the upper section 11 and thus, in contrast to the lower surface 31, also covers the entire cavity 29 of the lower section 12 with its tapered shape and hence, in terms of the light circuit, is not susceptible in relation to the exact positioning of one, two or three LEDs 30 between the SMD fastening points for the push button 1. In place of the cylinders 33 with a counterface in the region of the underside 27 appearing, for example, in the form of a collar between the guide frame 6 and the diffuser 5, as a counterpressure surface for compression springs 17, tensions springs can also be utilized, which are then mounted on corresponding stop collars on the upper section 12 and the frame 6.

In particular, this type of switch can be used, for example, for a video desk and the back of the printed circuit board 2 can then be equipped with further components, without limitation.

Thus, more functions can be accommodated in the same space. The lower section 12 of the push button 1, for example, is mounted on the printed circuit board 2 by means of a re-flow soldering process. Advantageously, the lamps 30 are SMD LEDs 30, which are mounted centrally between the contacts 22, 24 of the push button 1.

The lower section or contact support 12 is positioned on the printed circuit board 2 by hand (if the lugs 25 have been provided) or in an automated process and are then soldered with the printed circuit board 2 by means of a re-heating furnace soldering process. After cooling, the upper part of the button 11 can then be plugged into the lower part of the button or contact support 12 and can be clicked into the recesses 19 using the lugs 18.

A further object of the present invention is to guarantee the functionality of the switching system over a very large number of several hundred thousand switching operations. The push button described is not a completely encapsulated system, allowing contaminants to get into the housing over time via the upper section 11 and the lower section 12 and allowing the functionality of the switching system to be compromised.

In principle, the contact blade 10 is switched in the traditional manner by the actuation panel 9 of the frame 6 and there, in particular, by the contact lug 39 depicted in FIG. 3 against the counter contact 22. This contact blade 10 features an overhanging spring area 35 in the direction of the counter contact 22 for this purpose, while an opposing projection 36 is provided for the contact with the contact lug 39. The slotted contact blade 10 is now positioned across the elements 35 and 36 in the embodiment depicted. In the example of the realization depicted, there are three slots 37 running longitudinally over the spring 35 and recesses 36, which divide the contact blade 10 into four blades 38. If a contaminant now finds its way onto or under the contact blade 10, then it is very probable that, due to the size of the elements penetrated, these will only span a part of the area of the width of the blade and hence one or more blades will still be able to be actuated by the actuating lug 39.

It can also be seen in FIG. 4 that the lengths of the slots 37 are varied. In one advantageous embodiment with at least three blades 38 and hence two or more slots 37, it became apparent in experiments that it is very advantageous when the slots 37 are of varying lengths, such that only one slot 37 ends in the end range 40 of the contact blade 10 and the other slots 37 are set back and hence form a larger area of solid material of the flexible contact blade 10 on the apex of the contact blade 40. As a result, the number of cycles of operation can be increased by a factor of 5 to 10 in comparison with when all blade slots 37 are of the same length before material fatigue occurs. In particular, the blade slots 37 pass over the section forming the spring lug 35 across from the contact 22, however, not all pass over the opposing elevation 36 actuated by the lug 39.

LIST OF REFERENCE SYMBOLS

| | |
|---|---|
| 1 | Push button |
| 2 | Printed circuit board |
| 3 | Pressure cap |
| 4 | Front panel |
| 5 | Diffuser |
| 6 | Guide frame |
| 7 | Profile |
| 8 | Profile groove |
| 9 | Actuation groove |
| 10 | Contact blade |
| 11 | Upper section |
| 12 | Lower section/Contact support |
| 13 | Optical fiber |
| 14 | Notch |
| 15 | Lug |
| 16 | Lug |
| 17 | Spring |
| 18 | Snap-in lug |
| 19 | Lug seating |
| 20 | Contact support |
| 21 | Contact surface |
| 22 | Counter contact |
| 23 | Contact |
| 24 | Contact |
| 25 | Positioning guide |
| 26 | Blind hole |
| 27 | Underside |
| 28 | Recess |
| 29 | Aperture |
| 30 | LED |
| 31 | Base |
| 32 | Convex lens shape |
| 33 | Cylinder |
| 34 | Lug |
| 35 | Spring |
| 36 | Recess |
| 37 | Slot |
| 38 | Blade |
| 39 | Contact lug |
| 40 | End range |
| 41 | Recess |
| 42 | Underside |
| 43 | Longitudinal axis |

1-10. (canceled)

11. An electric surface-mount device (SMD) type switching element, comprising:
an actuating element, and
a body incorporating the switching element, the body comprising:
an upper section;
a lower section;
an underside provided at the lower section;
at least a first and a second contact surface, each comprising a first portion and a second portion, wherein the first portions are provided on the underside of the body for mounting it as an SMD;
a switching contact providing an electrically conducting connection between the second portion of the first contact surface and the second portion of the second contact surface, wherein the switching contact is closed by moving the actuating element relative to the switching contact;
a first catch mechanism provided at the upper section; and
a second catch mechanism provided at the lower section;
wherein the upper section incorporates the actuating element on a side opposing the underside of the body,
wherein the actuating element is movably connected to the body and moves along a longitudinal axis of the switching element,
wherein the lower section features the first and the second contact surfaces and the switching contact,
wherein the first catch mechanism of the upper section and the second catch mechanism of the lower section are complimentary for connecting the lower section to the upper section.

12. The switching element in accordance with claim 11, wherein the lower section comprises a thermostable plastic at temperatures occurring during soldering in an SMD mounting process.

13. The switching element in accordance with claim 11, wherein the lower section has a central opening delimited by side panels of the lower section.

14. The switching element in accordance with claim 13, wherein the actuating element connected to the upper section has a central optical fiber connected to the upper section, the central optical fiber comprising a lower edge having a predetermined clearance from the underside of the lower section when the switching element is assembled.

15. The switching element in accordance with claim 13, wherein the actuating element has a guide frame projecting into the upper section, which, viewed in a longitudinal direction of the switching element, has complimentary guide profiles.

16. The switching element in accordance with claim 15, wherein the complimentary guide profiles are recesses and complimentary profile lugs.

17. The switching element in accordance with claim 13, wherein the upper section has at least one spring bracket, wherein a spring is supported on the at least one spring bracket that presses against a counter surface on an underside of the actuating element.

18. An electric surface-mount device (SMD) type switching element, comprising:
an actuating element, and
a body incorporating the switching element, the body comprising:
an upper section;
a lower section;
an underside provided at the lower section;
at least a first and a second contact surface, each comprising a first portion and a second portion, wherein the first portions are provided on the underside of the body for mounting it as an SMD;
a switching contact providing an electrically conducting connection between the second portion of the first contact surface and the second portion of the second contact surface, wherein the switching contact is closed by moving the actuating element relative to the switching contact;
wherein the upper section incorporates the actuating element on a side opposing the underside of the body,
wherein the actuating element is movably connected to the body and moves along a longitudinal axis of the switching element,
wherein the lower section features the first and the second contact surface and the switching contact,
wherein the actuating element has an actuating lug, with which the first and second contact surfaces can be closed by moving the actuating element relative to the switching contact.

19. The switching element in accordance with claim 18, wherein the switching contact has a flexible blade connected to a first contact and an area projecting into a range of movement of the actuating lug.

20. The switching element in accordance with claim 18, wherein the switching contact is an elongated spring that is divided into at least two parallel flexible blades by at least one longitudinal slot.

21. The switching element in accordance with claim 20, wherein at least two longitudinal slots are provided, which are of varying lengths, whereby each of the at least two longitudinal slots at least pierces through a contact area between the at least two parallel flexible blades and at least one of the first and second contact surfaces, and at least one of the longitudinal slots projects into an end range of the flexible blades.

22. The switching element in accordance with claim 18, wherein the body further comprises:
a first catch mechanism provided at the upper section; and
a second catch mechanism provided at the lower section;
wherein the first catch mechanism of the upper section and the lower section are complimentary for connecting the lower section to the upper section.

23. The switching element in accordance with claim 22, wherein the temperatures occurring during soldering in the SMD mounting process are from about 180° C. to about 280° C. over a period of two minutes.
